(19) United States
(12) Patent Application Publication
(10) Pub. No.: US 2011/0231198 A1
(43) Pub. Date: Sep. 22, 2011

(54) System and Method of Generating Mailers from Online Interactions

(76) Inventor: Kenton Abel, Riverside, CA (US)

(21) Appl. No.: 13/049,873

(22) Filed: Mar. 16, 2011

Related U.S. Application Data
(60) Provisional application No. 61/314,578, filed on Mar. 16, 2010.

(51) Int. Cl. G06Q 10/00

(52) U.S. Cl. 705/1.1

(57) ABSTRACT

A system and method for generating a mailer that includes a computer open to receive electronic communications from a plurality of users, a database within the system to store personal information of a plurality of users, an interface open to receive a mailer demand from a sending user for a receiving user, checking for a physical address and appropriate permissions in the database for the receiving user and combining the information with the mailer demand, generating the mailer according to the mailer demand and the physical address of the receiving user, delivering the mailer to a postal authority with sufficient postage for delivery to the mailer to the receiving user. In the system and method, each receiving user controls one or more permissions for sending users to utilize and/or view the receiving user's data, the database stores at least one mailing address for each receiving user, each user may demand a minimum of one mailer, and the sending user is not notified of the receiving user's personal information without the receiving user.

This application claims priority to U.S. Provisional Application No. 61/314,578, filed Mar. 16, 2010, incorporated entirely by reference.

### BACKGROUND

With the adoption of the Internet world-wide, the ability to communicate with people from around the world has dramatically increased. Online social network services (e.g., Baboo®, Facebook®, MySpace®, Twitter®, and Windows Live Spaces® to name a few) collectively have hundreds of millions of users. Many times, users connect with each other online as “friends” and never meet in real life.

Online games (e.g., AstroEmpires®, Dungeons & Dragons Online®, EverQuest®, Final Fantasy®, Guild Wars®, Lineage®, RuneScape® and World of Warcraft® to name a few) also have many millions of users. Users of online games are often referred to as gamers. Most online games allow for their users to form groups called guilds. Guild members spend a great deal of time together online and often form good friendships. Online gamers often use an avatar's name and do not reveal their real names, even to others within the guild.

It is very prudent to not trust everyone that a user interacts with online, both for personal safety as well as identity theft concerns. Unfortunately, it is very difficult to tell who may be trusted and who should not be trusted. This means that it is often prudent to keep a user's personal information confidential from online friends, including home or physical mailing address, a user's real name, etc.

Online social networks allow for electronic communication between the users, but do not currently allow for sending physical letters or goods. The present invention allows for a user to send and receive physical letters and/or goods to another user without divulging personal information.

### DESCRIPTION

Systems currently exist for generating mailers. Examples of systems are described in, U.S. Pat. No. 6,135,292 to Gabriel Pettner, issued Oct. 24, 2000, titled “Method and system for presorting mail based on mail piece thickness,” and U.S. Pat. No. 7,369,918 to Rodger Cosgrove, issued May 6, 2008, titled “System and apparatus for generating mailers on demand,” and U.S. Ser. No. 12/916,029, to Rodger Cosgrove, titled “System and Method of Generating Postal Mailers for Free,” filed Oct. 29, 2010, all incorporated entirely by reference.

Systems also currently exist for sending goods from an electronic command. Almost all major companies sell goods on-line. Amazon.com®, for example, is perhaps best known for sending books, but a user may also order movies, music, games, toys, computer and office supplies, electronics, home furnishings, groceries, clothing, jewelry, sports and outdoors equipment, tools, etc. At the Target® and Walmart® websites, one may order almost anything found in the store and ship it to a physical address. All of these websites will store shipping information entered by a user. However, none of the current systems will share this information with other users or allow access to this information or sending a good to an address unknown to the Sender.

“Good” or “Goods” means a physical (tangible) product or products, capable of being delivered to a purchaser and involves the transfer of ownership from seller to customer.

“Document” means a custom printed communication, usually printed on flat paper or other substrate and may include graphic design or data.

“Electronic communication” is electronic transmission of information that has been encoded digitally, such as for storage and processing by computers. An electronic communication may be received by the system from any physical location. Ways of electronic communication includes, but are not limited to, e-mail, web servers, web sites, FTP transfer, cell phones, personal digital assistances, computer print drivers, etc.

“Envelope” means a carrier for the document. Envelopes may be standard open window or may be custom printed with graphics or other information tied to the document.

“Lettershop” means a service organization that prepares a large volume of Mailers.

“Mailer” means a physical document sent through a postal service and targeted to an addressee. A mailer may be a letter of one or more pages enclosed within an envelope. A mailer may also be a post card, large envelope, etc.

“Mailer Demand” means input into the Shipping System from a user that specifies the desired form set and all the data and targeting or addressing data necessary to generate the desired mailer. The mailer demand may come through any electronic communication.

“Mailer System” means a system used to physically generate a mailer after a mailer demand. The system includes a way to generate an envelope, in the case of a letter or card, with a current mail address for the addressee. The Mailer System is open via electronic communication to a plurality of users. The Mailer System also includes a database.

“Permissions” or “Access Rights” means the ability to specific users and groups of users to view, utilize or make changes to the contents of a database. Users are able to control Permissions to their own data, such as the ability to receive specific types of Mailers or Goods, the ability to control who may send Mailers or Goods, the ability of other users to view data, etc.

“Shipping System” means a system used to coordinate the delivery of a good from a sender to a receiver. They Mailer System is a specific subset of the Shipping System, wherein the good is a Mailer. The delivery method may be a postal service, or a private company such as FedEx®, DHL®, etc.

“Social Network” means social structure made up of individuals or organizations which are connected by one or more specific types of interdependency, such as friendship, kinship, common interest, financial exchange, dislike, sexual relationships, or relationships of beliefs, knowledge, prestige, etc.

“User” may be any natural person, business or other party, or even an automated system.

“Receiver” or “Receiving User” means a user who receives a Good.

“Sender” or “Sending User” means a user who is sending a Good. The Good may be a Mailer or other physical product.

“User interface” may be any means of communicating with the Mailer System. User interface includes, but is not limited to: an application on a social network system; an application on a smart phone; a program on a computer; a program on a personal digital assistance; an application on an iPod®, iPad®, Droid®, etc.

The Shipping System allows users to enter identifying information into the database. For example, a user may enter their real name or an avatar name. Users also enter or identify at least one mailing address. Mailing addresses include a home mailing address, a PO Box, a business address, a summer address, a vacation address, etc. Once a user has entered a mailing address into a database, the Mailer System may show others the availability of sending a mailer to the user. In a preferred embodiment, the mailer does not have the sender's physical return mailing address, but instead will be address as in care of (“c/o”) the address of the mail house generating mailer, e.g., “John Smith, c/o MailShop.”

The Mailer System may also have physical printing locations in various parts of the world. They may be one company with various print locations, or a network of cooperating companies.

The Mailer System may allow for tracking delivery of mailers with an Intelligent Mail Barcode. In a preferred embodiment, tracking not to show actual locations of delivery, only that letter has reached generic waypoints and/or it been delivered.

In one embodiment, the Mailer System will check database against National Change of Address (NCOA) and notify the sender and the addressee when a mailing address appears on the NCOA but is not updated in Mailer System database.

### EXAMPLE 1

A Facebook® user is checking her Facebook® account from an iPhone®. She sees that an online friend will have a birthday in a few days. The friend lives on the other side of the country and they have never met. The user opens an application for sending mailers to other Facebook® users. The online friend's address is in the database. The user selects a birthday card, customizes the text of the card, types a happy birthday message to the friend, sends the mailer request, and pays for the transaction using her iTunes® account. The Mailer System generates the birthday card, addresses the envelope with the online friend's physical mail address, and delivers the birthday card to the US Postal Service with sufficient postage to be delivered.

### EXAMPLE 2

A World of Warcraft® gamer in a guild learns some other guild members are husband and wife. The gamer learns that the husband and wife are celebrating an anniversary in a few days. The gamer opens a user interface to Mailer System, selects the avatar names of the husband and wife, selects a “Happy Anniversary” card, and sends a command to the system to send the card to the husband and wife wishing them happy anniversary. Unknown to the gamer is that the husband and wife live in Australia. The Mailer System generates the happy anniversary card in Australia using the real names of the husband and wife, addresses the card with the physical home address of the husband and wife in Australia, and delivers the card to the postal service with sufficient postage for delivery.

### EXAMPLE 3

A user of a social networking service wants to send out his holiday greeting cards. He opens a user interface to the Mailer System from his networking service account. He selects a “Happy Holidays” card, uploads a picture of himself and his cat, and uploads a black and white image of his signature. The user selects all of his networking service friends and sends a command to the system to send a card to each friend. The user has the physical address for some of his friends but not others. For those friends who have not uploaded their physical address, the user inputs a physical address. The user types a personal message to each friend. The Mailer System generates the “Happy Holidays” card with the picture of the user and his cat at the mail shop closest to the physical address of each addressee. Each card is personalized for each addressee, and is “signed” in blue ink with the image of the user's signature. The mail system addresses each card with the physical address selected by the user, and delivers the card to the postal service with sufficient postage for delivery.

### EXAMPLE 4

A school class is arranging for a 20-year reunion. The class representative opens a user interface to the Mailer System and locates the class members, such as a Facebook® page for class members. The class representative uploads an announcement of the weekend activities to the Mailer System, along with the addresses for the class members gathered at the 10-year reunion. The Mailer System checks the addresses and find many class members have moved. The Mailer System places the correct address on the announcements and delivers the announcements to the postal service with sufficient postage for delivery. The Mailer System notifies the class representative of the incorrect address but does not provide the new address unless authorized to do so by the receiving class member. In one example, a class member has set the Permissions to allow all members of the Facebook® class page to view their physical address, phone number and e-mail.

### EXAMPLE 5

A Sender who is a member of a dating website, such as eHarmony®, Match.com® or Zoosk®, wishes to send a card and flowers for Valentine's Day to several of the other members with whom he has been communicating. One of the Receiving members does not allow for receiving non-Mailer Goods. The Sender selects different flowers for each Receiver who allows non-Mailer Goods, and also personalizes a card for each. For the first Receiving member, the Sender only sends a card. The system generates the Mailers, matches the Mailers with the Goods if needed, and causes the Mailers and Goods to be delivered to the appropriate Receiver.

### EXAMPLE 6

Members of a guild on the online game Guildwars® want to coordinate a joint attack using a technique described in a book available from Amazon.com®. The guild president opens the mailer system application on his computer and orders the desired book for each guild member even though he only knows their online name. The mailer system places the order for the books and has them shipped to the real name and address of each member while charging the senders account for the purchases without revealing the true identity of the members.

### EXAMPLE 7

A member of an online Christian fellowship group wants to share a message given by one of his favorite speakers. He opens the mailer system interface and directs the purchase of the desired material from a web site. He then selects the recipients as his study group which only has online identities. The system makes the purchase and directs the online source of the material to send it to the real name and address of each selected recipient.

### EXAMPLE 8

A MySpace® User wishes to express her friendship to another member of MySpace®. This person opens the application to the Shipping System and sees the other person has their address in the data base. The Shipping System provides a catalog of available goods for friendship, camaraderie, romance, etc. The Sender selects a bottle of wine, and the Shipping System alerts her to the fact that this category of gift is not accepted for this Receiver's profile. Unknown to the Sender, the Receiver lives in a jurisdiction where alcohol is prohibited. The Shipping System suggests alternatives. The Sender then selects a box of chocolate. The Shipping System selects the closest physical seller to the Receiver of the box of chocolate help minimize cost and time of shipment and the Goods are sent to the Receiver without revealing any personal information.

### EXAMPLE 9

A member of an online political forum wants to send a book and movie he found on a topic of discussion to another member. He opens the Shipping System interface, locates the Goods, and directs the online purchase. The Shipping System sends the Goods to the Receiver. The Receiver doesn't care for the subject and simply returns the Goods to the retailer for a refund to the Sender.

### EXAMPLE 10

An adult dating website member wants to send a gift to another member of the same website. The Sender opens the Shipping System interface and finds the online identity of the Receiver listed. She also finds that gifts of a intimate nature are allowed by Receiver to be received. A purchase is made at a retail website and the gift is shipped to the real name and address of the Receiver without revealing the true identity of either of the members.

### EXAMPLE 11

A sporting goods store wants to increase sales. The store joins the Shipping System group “local Baseball Players Association.” The store sends all members of the group a coupon book good for discounts on baseball equipment. The store does not learn the real identity or address of the group members.

### EXAMPLE 12

A Sender wants to communicate with a Receiver by hand written letters. The Sender writes out a letter and addresses it with uniquely identifying information as found in the Shipping System. The Sender mails the letter to the Shipping System, and the Shipping System forwards the letter to the Receiver.

### EXAMPLE 13

An on-line book club is reading an out of print book. One of the members has several copies, while other members are unable to find a copy locally. The Sender packages each extra copy of the book and addresses it with uniquely identifying information as found in the Shipping System. She sends the books to the Shipping System, and the Shipping System forwards each book to the identified Receiver.

1. A method for generating a mailer, comprising:
a) a system comprising a computer open to receive electronic communications from a plurality of users,
b) a database within the system to store personal information of a plurality of users,
c) an interface open to receive a mailer demand from a sending user for a receiving user,
d) checking for a physical address and appropriate permissions in the database for the receiving user and combining the information with the mailer demand,
e) sending the mailer demand to a lettershop,
f) generating the mailer according to the mailer demand and the physical address of the receiving user,
g) delivering the mailer to a postal authority with sufficient postage for delivery to the mailer to the receiving user,
wherein each receiving user controls one or more permissions for sending users to utilize the receiving user's data,
wherein the database stores at least one mailing address for each receiving user,
wherein each user may demand a minimum of one mailer,
wherein the sending user is not notified of the receiving user's personal information.

2. The method of claim 1, wherein the users access the system via an online social network.

3. The method of claim 1, wherein the users access the system via an online game.
